(19) United States
(12) Patent Application Publication
(10) Pub. No.: US 2022/0075677 A1
(43) Pub. Date: Mar. 10, 2022

(54) METHOD AND APPARATUS WITH NEURAL NETWORK PROFILING

(71) Applicant: SAMSUNG ELECTRONICS CO., LTD., Suwon-si (KR)

(72) Inventor: Hyungtak JI, Ansan-si (KR)

(73) Assignee: SAMSUNG ELECTRONICS CO., LTD., Suwon-si (KR)

(21) Appl. No.: 17/145,935

(22) Filed: Jan. 11, 2021

(30) Foreign Application Priority Data
Sep. 8, 2020 (KR) 10-2020-0114564

(51) Int. Cl. G06F 11/07; G06N 3/04; G06F 9/54; G06F 11/30; G06N 5/04

(52) U.S. Cl. CPC G06F 11/0706; G06N 3/04; G06N 5/04; G06F 11/302; G06F 9/542

(57) ABSTRACT

A processor-implemented neural network method includes: receiving an event corresponding to a neural network operation and a control program for performing the neural network operation; detecting a missing event based on the event and the control program; and generating a profile of the neural network operation based on a result of the detecting.

### CROSS-REFERENCE TO RELATED APPLICATIONS

This application claims the benefit under 35 USC § 119(a) of Korean Patent Application No. 10-2020-0114564, filed on Sep. 8, 2020, in the Korean Intellectual Property Office, the entire disclosure of which is incorporated herein by reference for all purposes.

### BACKGROUND

### 1. Field

The following description relates to a method and apparatus with neural network profiling.

### 2. Description of Related Art

In a case of emulator inference, profiling may be performed on a neural processing unit (NPU) by uploading a register-transfer level (RTL) of the NPU into an emulator and a board executing the emulator and performing inference, and by downloading a log after the inference is completed and then performing profiling through parsing using profiling data.

In a case of target inference, event information may be obtained during the inference by connecting a hardware event signal of the NPU and an ARM system trace macrocell (STM) at a mobile phone kernel driver end.

Such a method may need a data post-processing process and use a great amount of time to perform profiling due to a large capacity of a log file. In addition, it may not be easy to determine a portion that is performed in a neural network in which the inference is currently performed, and profiling data may be inaccurate when an event log is missing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented neural network method includes: receiving an event corresponding to a neural network operation and a control program for performing the neural network operation; detecting a missing event based on the event and the control program; and generating a profile of the neural network operation based on a result of the detecting.

The event may include a start event and an end event of the neural network operation.

The control program may include an execution sequence of the neural network operation.

The detecting may include: determining whether the event matches an execution sequence comprised in the control program; and detecting the missing event based on a result of the determining.

The generating may include: determining a type of the missing event; and generating the profile by compensating for the missing event based on the determined type.

The generating of the profile by compensating for the missing event based on the type may include: in response to the type of the missing event being a start event, inserting the start event into the profile at a time determined by subtracting a first time amount from a subsequent event of the missing event.

The subsequent event may be an end event.

The generating of the profile by compensating for the missing event based on the type may include: in response to the type of the missing event being an end event, determining whether the neural network operation overlaps an event corresponding to another operation; and inserting the end event into the profile based on a result of the determining.

The inserting of the end event may include: in response to a determination that the neural network operation overlaps the event corresponding to the other operation, inserting the end event in a portion from which the overlapping starts.

The inserting of the end event may include: in response to a determination that the neural network operation does not overlap the event corresponding to the other operation, inserting the end event at a time determined by subtracting a second time amount from a subsequent event of the missing event.

The method may include: optimizing the neural network operation based on the generated profile; and performing inference using the optimized neural network operation, wherein the neural network operation may include any one of a convolution, a padding, a pooling, and a reformatting.

A non-transitory computer-readable storage medium may store instructions that, when executed by a processor, configure the processor to perform the method.

In another general aspect, a neural network apparatus includes: a receiver configured to receive an event corresponding to a neural network operation and a control program for performing the neural network operation; and a processor configured to detect a missing event based on the event and the control program, and generate a profile of the neural network operation based on a result of the detecting.

The event may include a start event and an end event of the neural network operation.

The control program may include an execution sequence of the neural network operation.

For the detecting, the processor may be configured to: determine whether the event matches an execution sequence comprised in the control program; and detect the missing event based on a result of the determining.

For the generating, the processor may be configured to: determine a type of the missing event; and generate the profile by compensating for the missing event based on the determined type.

For the generating of the profile by compensating for the missing event based on the type, the processor may be configured to: in response to the type of the missing event being a start event, insert the start event into the profile at a time determined by subtracting a first time amount from a subsequent event of the missing event.

For the generating of the profile by compensating for the missing event based on the type, the processor may be configured to: in response to the type of the missing event being an end event, determine whether the neural network operation overlaps an event corresponding to another operation; and insert the end event into the profile based on a result of the determining.

For the inserting of the end event, the processor may be configured to: in response to a determination that the neural network operation overlaps the event corresponding to the other operation, insert the end event in a portion from which the overlapping starts.

For inserting of the end event, the processor may be configured to: in response to a determination that the neural network operation does not overlap the event corresponding to the other operation, insert the end event at a time determined by subtracting a second time amount from a subsequent event of the missing event.

In another general aspect, a processor-implemented neural network method includes: detecting a missing event by determining that an event corresponding to a neural network operation does not match an execution sequence included in a control program for performing the neural network operation; and generating a profile of the neural network operation by inserting the missing event of the profile based on a type of the missing event.

Other features and aspects will be apparent from the following detailed description, the drawings, and the claims.

### BRIEF DESCRIPTION OF THE DRAWINGS

FIG. 1 illustrates an example of a profiling apparatus.

FIG. 2 illustrates an example of a neural network processing system.

FIG. 3 illustrates an example of an operation of a profiling apparatus.

FIG. 4 illustrates an example of an operation performed by a profiling apparatus to compensate for a missing event.

FIG. 5 illustrates an example of visualization performed by a profiling apparatus.

FIG. 6 illustrates an example of a profiling method performed by a profiling apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component is described as being “on,” “connected to,” or “coupled to” another component, it may be directly “connected to,” or “coupled to” the other component, or there may be one or more other components intervening therebetween. In contrast, when an element is described as being “directly on,” “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various embodiments only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein. The use of the term “may” herein with respect to an example or embodiment (e.g., as to what an example or embodiment may include or implement) means that at least one example or embodiment exists where such a feature is included or implemented, while all examples are not limited thereto.

Also, in the description of example embodiments, detailed description of structures or functions that are thereby known after an understanding of the disclosure of the present application will be omitted when it is deemed that such description will cause ambiguous interpretation of the example embodiments.

Hereinafter, examples will be described in detail with reference to the accompanying drawings, and like reference numerals in the drawings refer to like elements throughout.

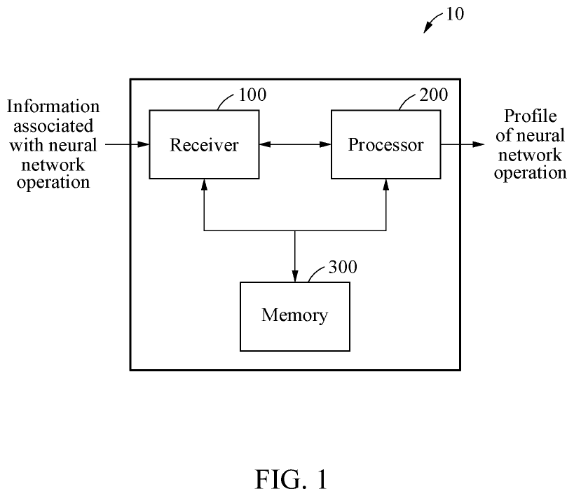

FIG. 1 illustrates an example of a profiling apparatus.

A profiling apparatus 10 may perform neural network profiling. The profiling apparatus 10 may perform profiling associated with an operation performed in a neural network.

The profiling may be or include a dynamic program analysis that measures a time complexity and a space (e.g., a memory) of a program, the use of a certain instruction, a period and frequency of a function call, and the like. Profiling information may be used to assist the optimization of the neural network. The profiling apparatus 10 may perform profiling by analyzing a program source code or a binary execution file.

A profile may be or include data generated through the profiling. The profile may indicate an event associated with an operation of the neural network (or a neural network operation hereinafter) that is performed based on time.

The neural network may include a statistical learning algorithm used in machine learning. The neural network may indicate an overall model having a problem-solving ability as nodes constituting a network through synaptic connections change an intensity of the synaptic connections through learning.

The neural network may include a deep neural network (DNN). For example, the neural network may include a convolutional neural network (CNN), a recurrent neural network (RNN), a perceptron, a feedforward (FF) network, a radial basis function (RBF) network, a deep FF (DFF) network, a long short-term memory (LSTM), a gated recurrent unit (GRU), an autoencoder (AE), a variational AE (VAE), a denoising AE (DAE), a sparse AE (SAE), a Markov chain (MC), a Hopfield network (HN), a Boltzmann machine (BM), a restricted BM (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and/or an attention network (AN).

The profiling apparatus 10 may generate a profile based on an event associated with a neural network operation and visualize the generated profile.

By generating the profile of the neural network operation, the profiling apparatus 10 may verify or determine whether a computation time suitable for a hardware specification that is predicted or determined in an inference process of a neural network model is used, and whether the neural network operation is performed in accordance with a predicted cycle. In addition, the profiling apparatus 10 may detect an optimization point of the neural network using the generated profile.

The profiling apparatus 10 may generate the profile of the neural network operation by processing information associated with the neural network operation. The information associated with the neural network operation may include an event associated with the neural network operation and a control program for performing the neural network operation.

The event may indicate start and end based on a type of the neural network operation. The event may include a start event and an end event of the neural network operation.

The control program may include a program generated by a compiler to perform inference using the neural network. The control program may include a neural network operator intrinsic sequence (e.g., an intrinsic). Here, the term “intrinsic” may indicate a built-in function of a neural processing unit (NPU) (e.g., neural processor) that performs a neural network operation. For example, the control program may include an execution sequence of the neural network operation.

Referring to FIG. 1, the profiling apparatus 10 may include a receiver 100, a processor 200 (e.g., one or more processors), and a memory 300.

The receiver 100 may receive an event associated with a neural network operation and a control program for performing the neural network operation.

The receiver 100 may output the received event and the received control program to the processor 200. The receiver 100 may include a receiving interface.

The processor 200 may process data stored in the memory 300. The processor 200 may execute computer-readable instructions stored in the memory 300 that configure the processor 200 to perform operations.

The processor 200 may be a hardware data processing device having a circuit of a physical structure to execute desired operations. The desired operations may include a code or instructions included in a program, for example.

The data processing device may include, for example, a microprocessor, a central processing unit (CPU), a processor core, a multicore processor, a multiprocessor, an application-specific integrated circuit (ASIC), and/or a field-programmable gate array (FPGA).

The processor 200 may detect a missing event based on the event and the control program. The missing event may be an event that is supposed or intended to be included in an intrinsic of the control program and be performed in a processing process of the neural network, but is not included in the received event.

The processor 200 may determine whether the event matches the execution sequence included in the control program, and may detect the missing event based on a result of the determining.

The processor 200 may generate a profile of the neural network operation based on a result of detecting the missing event. The processor 200 may determine a type of the missing event. The processor 200 may generate the profile by compensating for the missing event based on the determined type.

When the type of the missing event corresponds (or is determined to correspond) to the start event, the processor 200 may insert the start event at a time of the profile obtained by subtracting a first time amount from a subsequent event of the missing event.

When the type of the missing event corresponds (or is determined to correspond) to the end event, the processor 200 may determine whether the neural network operation overlaps an event associated with another operation, and may insert the end event based on a result of the determining.

When the neural network operation overlaps (or is determined to overlap) the event associated with the other operation, the processor 200 may insert the end event in a portion from which the overlapping starts. When the neural network operation does not overlap (or is determined not to overlap) the event associated with the other operation, the processor 200 may insert the end event at a time obtained by subtracting a second time amount from the subsequent event of the missing event.

The memory 300 may store instructions (or a program) executable by the processor 200. For example, the instructions may include instructions to execute an operation of the processor 200 and/or an operation of each component of the processor 200.

The memory 300 may be a volatile or nonvolatile memory device.

The volatile memory device may be, for example, a dynamic random-access memory (DRAM), a static RAM (SRAM), a thyristor RAM (T-RAM), a zero-capacitor RAM (Z-RAM), and/or a twin-transistor RAM (TTRAM).

The nonvolatile memory device may be, for example, an electrically erasable programmable read-only memory (EEPROM), a flash memory, a magnetic RAM (MRAM), a spin-transfer torque (STT) MRAM (STT-MRAM), a conductive bridging RAM (CBRAM), a ferroelectric RAM (FeRAM), a phase-change RAM (PRAM), a resistive RAM (RRAM), a nanotube RRAM, a polymer RAM (PoRAM), a nano-floating gate memory (NFGM), a holographic memory, a molecular electronic memory device, and/or an insulator resistance change memory.

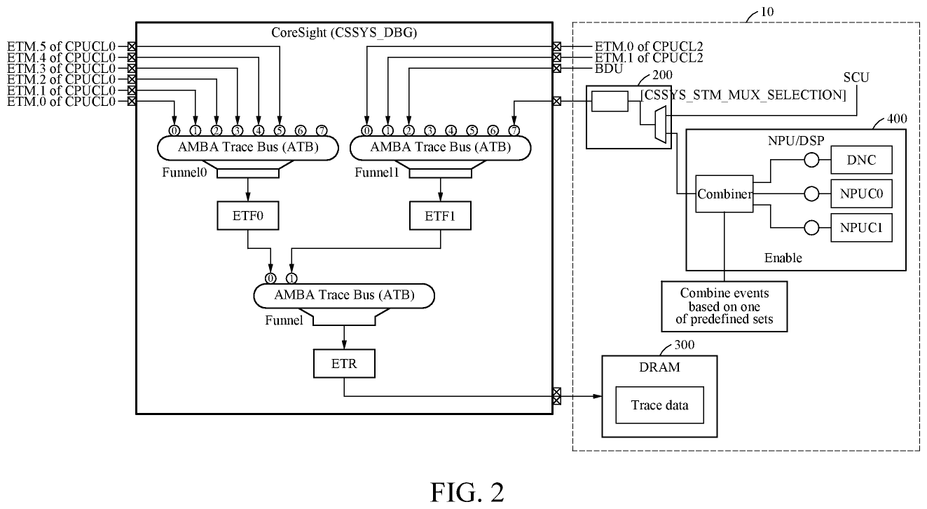

FIG. 2 illustrates an example of a neural network processing system.

Referring to FIG. 2, in a neural network processing system, the profiling apparatus 10 and a system component may transmit and receive information associated with a neural network operation to and from each other. The system component may perform debugging and performance measurement. The system component may include CoreSight, for example.

The profiling apparatus 10 may include the processor 200 and the memory 300, and may further include an operator 400. The memory 300 may be a DRAM. The memory 300 may store trace data.

The operator 400 may be provided inside or outside the profiling apparatus 10.

The operator 400 may include an NPU or a digital signal processor (DSP). The operator 400 may include a combiner. The combiner may define an event in advance. The combiner may combine events based on one of predefined sets.

The processor 200 may receive an event associated with a neural network operation from the operator 400. The processor 200 may generate a neural network profile by compensating for a missing event by comparing the received event and a control program.

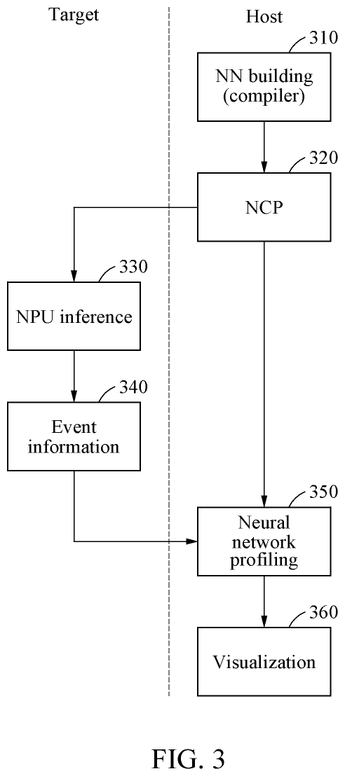

FIG. 3 illustrates an example of an operation of a profiling apparatus (e.g., the profiling apparatus 10 illustrated in FIG. 1).

Referring to FIG. 3, the profiling apparatus 10 may be included in a host apparatus. The host apparatus may be, for example, a personal computer (PC) or a server. The profiling apparatus 10 may receive event information associated with an operation performed in a target device, and perform profiling on a neural network operation.

The host apparatus may include a compiler. In operation 310, the compiler may build a neural network. In operation 320, the compiler may generate a control program. For example, the compiler may generate a network control program (NCP) which is an execution file for an NPU.

The target device may be or include a device in which inference is performed using the neural network. The target device may be, for example, an Internet of things (IoT) device, a machine-type communication device, and a portable electronic device.

The portable electronic device may include, for example, a laptop computer, a mobile phone, a smartphone, a tablet PC, a mobile Internet device (MID), a personal digital assistant (PDA), an enterprise digital assistant (EDA), a digital still camera, a digital video camera, a portable multimedia player (PMP), a personal or portable navigation device (PND), a handheld game console, an e-book, a smart device, and the like. The smart device may include, for example, a smart watch and a smart band.

The target device may include an NPU. In operation 330, the target device may perform inference using the NPU configured to perform an operation included in the neural network. In operation 340, the target device may generate event information while performing the inference. In one or more non-limiting examples, the target device may include the host apparatus.

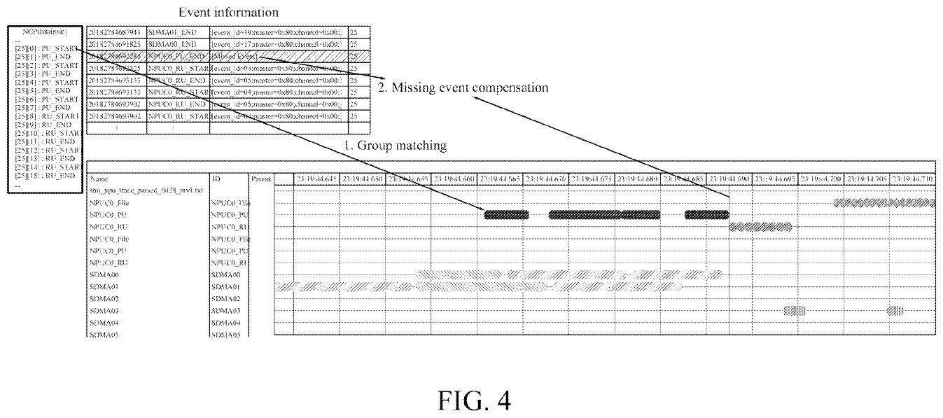

The receiver 100 may receive the event information and the control program. In operation 350, the processor 200 may perform neural network profiling based on the event information and the control program. A non-limiting example of the performing of the profiling will be further described in detail below with reference to FIG. 4.

In operation 360, the processor 200 may perform visualization based on a generated profile.

FIG. 4 illustrates an example of an operation performed by a profiling apparatus (e.g., the profiling apparatus 10 illustrated in FIG. 1) to compensate for a missing event.

Referring to FIG. 4, the processor 200 may detect a missing event based on an event and a control program. A compiler may generate the control program and transfer the generated control program. The control program may include, for example, an NCP.

The NCP may have a group as an execution unit. Through the group, a network performing point may be estimated.

In the example of FIG. 4, the NCP (or intrinsic) generated by the compiler may include an execution sequence of a neural network operation. Event information may be generated and transmitted by an NPU. The event information may be received in a form of a data file.

The event information and the control program (e.g., the NCP (or intrinsic)) may include the neural network operation and the event associated with the neural network operation. For example, in FIG. 4, “File” may indicate a convolution operation, “PU” may indicate a pad/pool operation, and “RU” may indicate a reformat operation. Each operation may have a start event and an end event.

The processor 200 may determine whether the event matches the execution sequence included in the control program, and may detect the missing event based on a result of the determining.

For example, the processor 200 may detect the missing event by determining that the File, PU, and RU operations are not performed simultaneously.

The processor 200 may generate a profile of the neural network operation based on a result of detecting the missing event. The processor 200 may determine a type of the missing event. The processor 200 may generate the profile by compensating for the missing event based on the determined type.

For example, when the type of the missing event is a start event, the processor 200 may insert the start event at a time obtained by subtracting a first time amount from a subsequent event (e.g., an end event) of the missing event.

Here, when the type of the missing event is the start event, the processor 200 may insert the start event at a time obtained by subtracting a first time amount from the end event, because whether the start event occurs while direct memory access (DMA) is being performed before the start event or the start event proceeds immediately after an event of another operator is finished may be unknown.

The first time amount may differ depending on an operation type and hardware. For example, the first time amount may be 10 nanoseconds (ns). For example, the first time amount may be predetermined based on the operation type and/or the hardware.

When the type of the missing event is the end event, the processor 200 may determine whether the neural network operation overlaps an event associated with another operation. The processor 200 may insert the end event based on a result of the determining.

For example, when the neural network operation overlaps the event associated with the other operation, the processor 200 may insert the end event in a portion from which the overlapping starts. When the neural network operation does not overlap the event associated with the other operation, the processor 200 may insert the end event at a time obtained by subtracting a second time amount from the subsequent event of the missing event. The second time amount may differ depending on an operation type and hardware. For example, the second time amount may be 10 ns. For example, the second time amount may be predetermined based on the operation type and/or the hardware.

When the event overlaps, the processor 200 may determine that an operation in the overlapping portion is invalid. The processor 200 may compensate for the missing event not to have such an overlapping portion.

For example, in a case in which both the start event and the end event are missing or three or more events are missing, the processor 200 may perform compensation by inserting the missing events at a time obtained by subtracting a time amount obtained by multiplying a third time amount by a predetermined index based on a time at which an initially received event occurs after the missing events.

The third time amount may differ depending on an operation type and hardware. For example, the third time amount may be 10 ns.

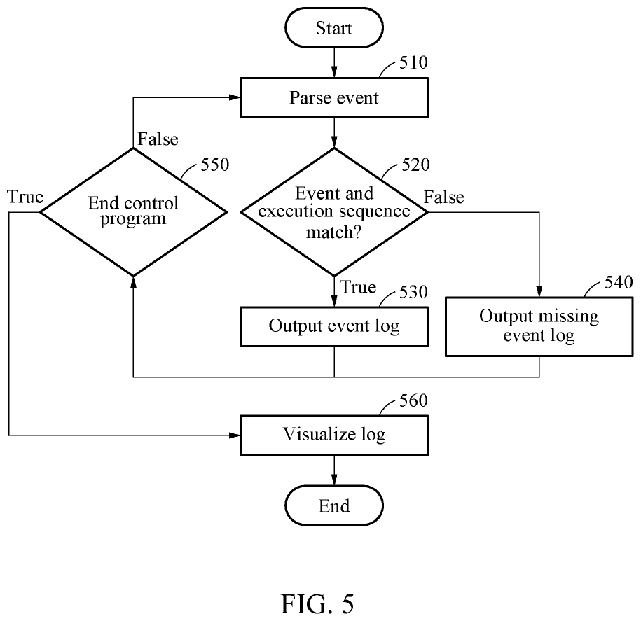

FIG. 5 illustrates an example of visualization performed by a profiling apparatus (e.g., the profiling apparatus 10 illustrated in FIG. 1).

Referring to FIG. 5, in operation 510, the processor 200 may parse a received event. The processor 200 may perform event parsing by verifying an event packet recorded in event information (e.g., event file). The event packet may include a timestamp, an event identity (ID), and an event type of an event. The event ID may include File, PU, and RU as described above with reference to FIG. 4, and the event type may include a start event and an end event.

In operation 520, the processor 200 may determine whether the event matches an execution sequence. For example, the processor 200 may determine whether the event matches the execution sequence by determining whether a start event and an end event of a neural network operation are received in accordance with the execution sequence included in a control program.

In operation 530, when the event matches the execution sequence of the neural network operation, the processor 200 may output an event log. In operation 540, when the event does not match the execution sequence, the processor 200 may output a missing event log.

The processor 200 may generate a profile by outputting the event log or the missing event log. In operation 550, after the outputting of the event log or the missing event log is completed, the processor 200 may end the control program. In operation 560, after the control program is ended, the processor 200 may visualize the generated profile.

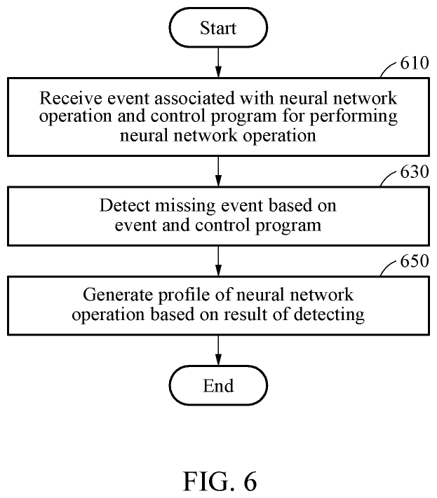

FIG. 6 illustrates an example of a profiling method performed by a profiling apparatus (e.g., the profiling apparatus 10 illustrated in FIG. 1).

Referring to FIG. 6, in operation 610, the receiver 100 may receive an event associated with a neural network operation and a control program for performing the neural network operation.

In operation 630, the processor 200 may detect a missing event based on the event and the control program. For example, the processor 200 may determine whether the event matches an execution sequence included in the control program. The processor 200 may detect the missing event based on a result of the determining (e.g., the processor 200 may detect the missing event in response to the event not matching the execution sequence).

In operation 650, the processor 200 may generate a profile of the neural network operation based on a result of detecting the missing event. For example, the processor 200 may determine a type of the missing event. The processor 200 may generate the profile by compensating for the missing event based on the determined type.

For example, when the type of the missing event is a start event, the processor 200 may insert the start event at a time obtained by subtracting a first time amount from a subsequent event of the missing event.

When the type of the missing event is an end event, the processor 200 may determine whether the neural network operation overlaps an event associated with another operation. The processor 200 may insert the end event based on a result of the determining.

When the neural network operation overlaps the event associated with the other operation, the processor 200 may insert the end event in a portion from which the overlapping starts. When the neural network operation does not overlap the event associated with the other operation, the processor 200 may insert the end event at a time obtained by subtracting a second time amount from the subsequent event of the missing event.

The profiling apparatuses, receivers, processors, memories, neural network processing systems, operators, system components, profiling apparatus 10, receiver 100, processor 200, memory 300, operator 400, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A processor-implemented neural network method, comprising:
receiving an event corresponding to a neural network operation and a control program for performing the neural network operation;
detecting a missing event based on the event and the control program; and
generating a profile of the neural network operation based on a result of the detecting.

2. The method of claim 1, wherein the event comprises a start event and an end event of the neural network operation.

3. The method of claim 1, wherein the control program comprises an execution sequence of the neural network operation.

4. The method of claim 1, wherein the detecting comprises:
determining whether the event matches an execution sequence comprised in the control program; and
detecting the missing event based on a result of the determining.

5. The method of claim 1, wherein the generating comprises:
determining a type of the missing event; and
generating the profile by compensating for the missing event based on the determined type.

6. The method of claim 5, wherein the generating of the profile by compensating for the missing event based on the type comprises:
in response to the type of the missing event being a start event, inserting the start event into the profile at a time determined by subtracting a first time amount from a subsequent event of the missing event.

7. The method of claim 6, wherein the subsequent event is an end event.

8. The method of claim 5, wherein the generating of the profile by compensating for the missing event based on the type comprises:
in response to the type of the missing event being an end event, determining whether the neural network operation overlaps an event corresponding to another operation; and
inserting the end event into the profile based on a result of the determining.

9. The method of claim 8, wherein the inserting of the end event comprises:
in response to a determination that the neural network operation overlaps the event corresponding to the other operation, inserting the end event in a portion from which the overlapping starts.

10. The method of claim 8, the inserting of the end event comprises:
in response to a determination that the neural network operation does not overlap the event corresponding to the other operation, inserting the end event at a time determined by subtracting a second time amount from a subsequent event of the missing event.

11. The method of claim 1, further comprising:
optimizing the neural network operation based on the generated profile; and
performing inference using the optimized neural network operation, wherein the neural network operation comprises any one of a convolution, a padding, a pooling, and a reformatting.

12. A non-transitory computer-readable storage medium storing instructions that, when executed by a processor, configure the processor to perform the method of claim 1.

13. A neural network apparatus, comprising:
a receiver configured to receive an event corresponding to a neural network operation and a control program for performing the neural network operation; and
a processor configured to
detect a missing event based on the event and the control program, and
generate a profile of the neural network operation based on a result of the detecting.

14. The apparatus of claim 13, wherein the event comprises a start event and an end event of the neural network operation.

15. The apparatus of claim 13, wherein the control program comprises an execution sequence of the neural network operation.

16. The apparatus of claim 13, wherein, for the detecting, the processor is configured to:
determine whether the event matches an execution sequence comprised in the control program; and
detect the missing event based on a result of the determining.

17. The apparatus of claim 13, wherein, for the generating, the processor is configured to:
determine a type of the missing event; and
generate the profile by compensating for the missing event based on the determined type.

18. The apparatus of claim 17, wherein, for the generating of the profile by compensating for the missing event based on the type, the processor is configured to:
in response to the type of the missing event being a start event, insert the start event into the profile at a time determined by subtracting a first time amount from a subsequent event of the missing event.

19. The apparatus of claim 17, wherein, for the generating of the profile by compensating for the missing event based on the type, the processor is configured to:
in response to the type of the missing event being an end event, determine whether the neural network operation overlaps an event corresponding to another operation; and
insert the end event into the profile based on a result of the determining.

20. The apparatus of claim 19, wherein, for the inserting of the end event, the processor is configured to:
in response to a determination that the neural network operation overlaps the event corresponding to the other operation, insert the end event in a portion from which the overlapping starts.

21. The apparatus of claim 19, wherein, for inserting of the end event, the processor is configured to:
in response to a determination that the neural network operation does not overlap the event corresponding to the other operation, insert the end event at a time determined by subtracting a second time amount from a subsequent event of the missing event.

22. A processor-implemented neural network method, comprising:
detecting a missing event by determining that an event corresponding to a neural network operation does not match an execution sequence included in a control program for performing the neural network operation; and
generating a profile of the neural network operation by inserting the missing event of the profile based on a type of the missing event.
